(19) United States
(12) Patent Application Publication
(10) Pub. No.: US 2011/0206984 A1
(43) Pub. Date: Aug. 25, 2011

(54) PRESEALED ANODE TUBE

(75) Inventors: Chandra Sekher Yerramalli, Niskayuna, NY (US); Anil Raj Duggal, Niskayuna, NY (US); Andrew Philip Shapiro, Schenectady, NY (US); Mohamed Rahmane, Ballston Lake, NY (US); Reza Sarrafi-Nour, Clifton Park, NY (US); Gregory John Parker, Latham, NY (US); Alireza Namazifard, Saratoga Springs, NY (US); Badri Narayan Ramamurthi, Clifton Park, NY (US); James Lowe Sudworth, Burton on Trent (GB); Sylvia Marie DeCarr, Schenectady, NY (US)

(73) Assignee: GENERAL ELECTRIC COMPANY, SCHENECTADY, NY (US)

(21) Appl. No.: 12/712,457

(22) Filed: Feb. 25, 2010

(51) Int. Cl. H01M 2/08; H01M 4/82

(52) U.S. Cl. 429/185; 29/623.2

(57) ABSTRACT

A pre-sealed anode tube assembly for a sodium-metal-halide energy storage device includes an anode tube and a feed-through current collector assembly at least partially sealed within the anode tube. The pre-sealed anode tube assembly can be independently transported prior to being integrated with a desired sodium-metal-halide energy storage device.

### BACKGROUND

The invention relates generally to energy storage devices, and more particularly to a pre-sealed anode tube structure for implementing sodium-metal-halide energy storage devices that exhibit an operational life and power density suitable for use in providing cost-effective and reliable electric energy storage solutions for electrical power grid renewable firming applications.

The greatest potential for significantly reducing green house gas emissions and reducing the USA's petroleum consumption lies with the development and growth of renewable energy sources, such as wind and solar. To be optimally effective, a high penetration of these renewable energy sources into the electrical grid is necessary, as well as widespread electrification of the transportation systems. For either of these to occur, cost-effective and reliable electric energy storage solutions capable of delivering a wide range of power capabilities are needed.

When intermittent renewable power sources are connected to a power grid, other power sources on the grid need to modulate their output in order to make up for the intermittency and ensure stable power output. The modulation service provided by these other sources is referred to as frequency regulation or renewable firming. At present, renewable firming is accomplished through the adjustment of output from excess conventional coal or gas power-generating units. However, as the renewable reaction of the grid power increases, an alternative non-green house gas emitting solution is desired.

Desirably, a highly reliable anode tube structure for sodium sulfur cells or sodium-metal-halide cells would be provided to enable highly efficient and cost effective production of energy storage devices that exhibit acceptable operational life suitable for use in renewable firming applications.

### BRIEF DESCRIPTION

According to one embodiment, a sodium-metal-halide energy storage device anode tube assembly comprises an anode tube comprising a feed-through current collector assembly at least partially sealed therein such that at least one portion of the feed-through current collector assembly is maintained at a pressure level within the sealed anode tube below atmospheric pressure.

According to another embodiment, an energy storage device anode tube and a feed-through current collector assembly are together configured to form a pre-sealed anode tube assembly for a sodium-metal-halide energy storage device such that the pre-sealed anode tube assembly can be independently transported prior to being integrated with a desired sodium-metal-halide energy storage device.

According to yet another embodiment, a method of forming a pre-sealed anode tube for a sodium-metal-halide energy storage device comprises attaching an anode current collector to a shim via a metal-metal joint to form a collector-shim assembly, attaching a ceramic insulator to the collector-shim assembly via a ceramic-metal joint to form a feed-through current collector assembly, inserting the feed-through current collector assembly into a solid electrolyte tube, and evacuating and sealing the solid electrolyte tube to form a pre-sealed anode tube assembly wherein at least one portion of the feed-through current collector assembly is maintained at a pressure level within the pre-sealed anode tube below atmospheric pressure.

### DRAWINGS

These and other features, aspects, and advantages of the present invention will become better understood when the following detailed description is read with reference to the accompanying drawings in which like characters represent like parts throughout the drawings, wherein:

FIG. 1 is a process diagram showing a method for assembling a pre-sealed anode tube according to one embodiment of the invention;

FIG. 2 illustrates one embodiment of a pre-sealed anode tube formed during the process depicted in FIG. 1;

FIG. 3 illustrates one embodiment of an energy storage device configured with a plurality of the pre-sealed anode tubes shown in FIG. 2;

FIG. 4 is a top view of a pre-sealed anode tube shim assembly according to one embodiment;

FIG. 5 is a perspective view of the pre-sealed anode tube shim assembly depicted in FIG. 4;

FIG. 6 illustrates one portion of a rolled metal anode tube shim assembly according to one embodiment;

FIG. 7 is a top view of a coiled wire anode tube shim assembly according to one embodiment;

FIG. 8 is a side view of the coiled wire anode tube shim assembly depicted in FIG. 7; and

FIG. 9 illustrates a cross-sectional view of a portion of the shim depicted in FIGS. 7 and 8.

While the above-identified drawing figures set forth particular embodiments, other embodiments of the present invention are also contemplated, as noted in the discussion. In all cases, this disclosure presents illustrated embodiments of the present invention by way of representation and not limitation. Numerous other modifications and embodiments can be devised by those skilled in the art which fall within the scope and spirit of the principles of this invention.

### DETAILED DESCRIPTION

Unless defined otherwise, technical and scientific terms used herein have the same meaning as is commonly understood by one of skill in the art to which this invention belongs. The terms “first”, “second”, and the like, as used herein do not denote any order, quantity, or importance, but rather are used to distinguish one element from another. Also, the terms “a” and “an” do not denote a limitation of quantity, but rather denote the presence of at least one of the referenced item, and the terms “front”, “back”, “bottom”, and/or “top”, unless otherwise noted, are merely used for convenience of description, and are not limited to any one position or spatial orientation. If ranges are disclosed, the endpoints of all ranges directed to the same component or property are inclusive and independently combinable (e.g., ranges of “up to about 25 wt. %, or, more specifically, about 5 wt. % to about 20 wt. %,” is inclusive of the endpoints and all intermediate values of the ranges of “about 5 wt. % to about 25 wt. %,” etc.). The modifier “about” used in connection with a quantity is inclusive of the stated value and has the meaning dictated by the context (e.g., includes the degree of error associated with measurement of the particular quantity).

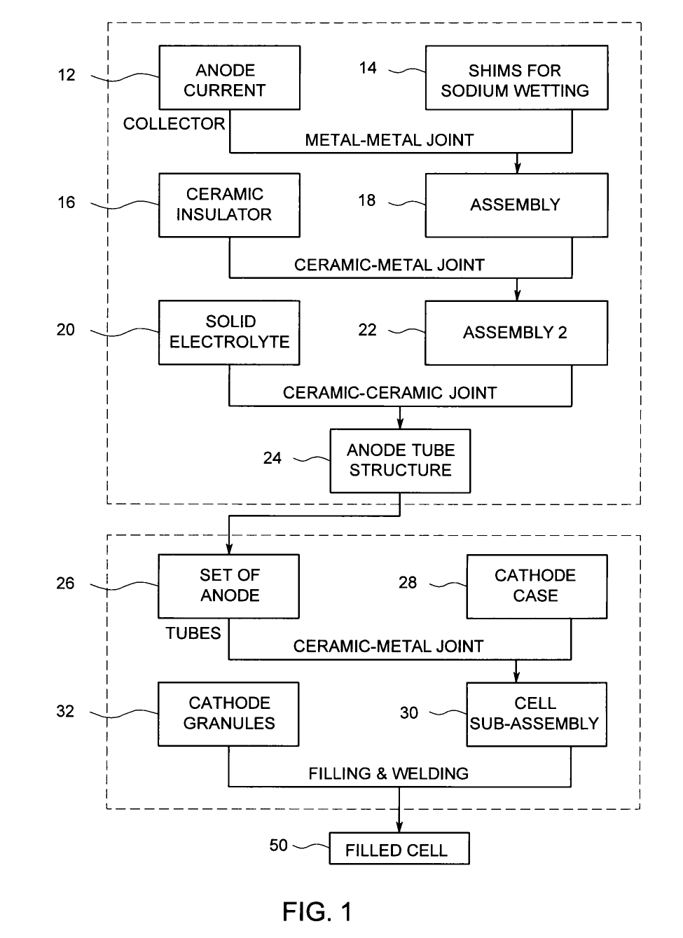

FIG. 1 is a process diagram 10 illustrating assembly of a pre-sealed anode tube according to one embodiment that is useful for implementing a sodium-metal-halide energy storage device that exhibits an operational life and power density suitable for use in providing cost-effective and reliable electric energy storage solutions for electrical power grid renewable firming applications. A pre-sealed anode tube can be assembled with reference to FIG. 1 by first attaching an anode current collector to a shim assembly via a metal-metal joint as represented in blocks 12 and 14. The resultant collector-shim assembly is then attached to a ceramic insulator via a ceramic-metal joint as represented in blocks 16 and 18 to form a feed-through current collector. The feed-through current collector is finally inserted into a solid electrolyte tube and sealed via a ceramic-ceramic joint to form an anode tube structure as represented in blocks 20-24.

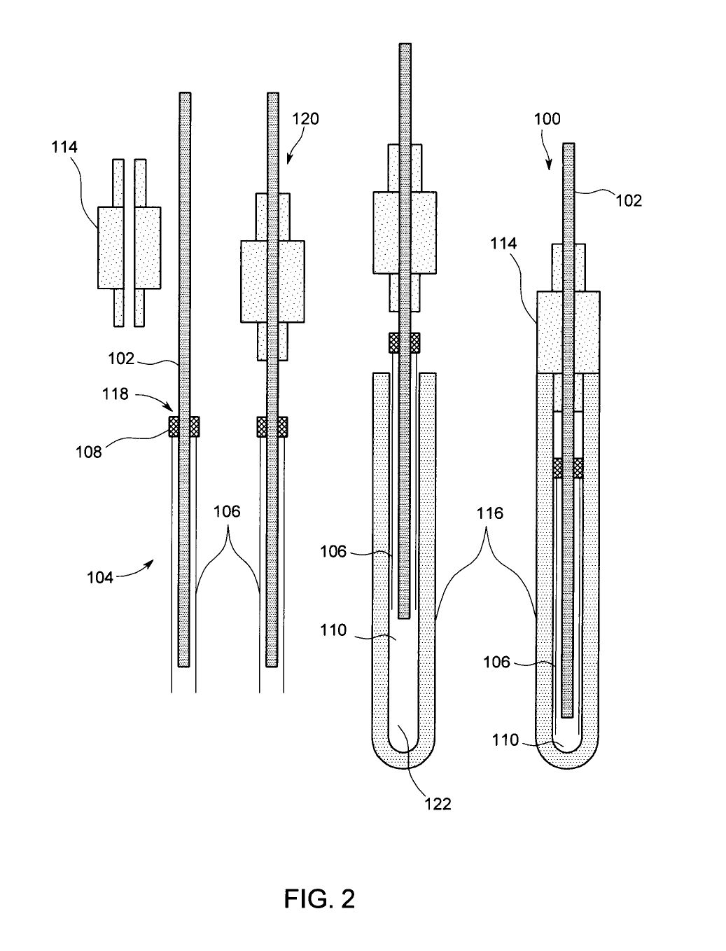

The resultant anode tube structure, described in further detail below with reference to FIG. 2, includes an anode cavity 122 that is sealed from the outside atmosphere to form a pre-sealed anode tube 100. According to one aspect, the anode cavity 122 is sealed during the foregoing assembly process that may take place under vacuum or low atmospheric conditions. According to another aspect, the anode cavity 122 is sealed by pulling a vacuum through the anode current collector 102 that may be, for example, and without limitation, a hypodermic needle type structure, and then sealing the anode current collector 102 via a suitable welding or crimping procedure.

According to one aspect, a plurality of the resultant anode tube structures (anode tube assemblies) may be inserted into and attached to a predetermined cathode case via a ceramic-metal joint as represented in blocks 26 and 28 to form a cell sub-assembly as represented in block 30. The resultant cell sub-assembly is then filled with a desired amount of cathode granules as represented in block 32 and subsequently sealed via a predetermined welding process to form a completed sodium-metal-halide energy storage device.

FIG. 2 illustrates one embodiment of a pre-sealed anode tube 100 formed during the process 10 described above with reference to FIG. 1. Pre-sealed anode tube 100 can be seen to include an anode current collector 102, a shim assembly 104 disposed inside anode tube 100 that includes a shim 106 supported via a shim support collar 108, a ceramic insulator 114, and a solid electrolyte anode tube 116. According to one aspect, the anode current collector 102 is attached to the shim assembly 104 via a metal-metal joint 118 and the ceramic insulator 114 is attached to the current collector 102 via a ceramic-metal joint 120 to form a feed-through current collector 120. Feed-through current collector 120 is inserted (or deployed) in to the solid electrolyte anode tube 116 and is sealed or joined to the solid electrolyte tube via a ceramic-ceramic joint according to one aspect to form a pre-sealed anode tube chamber 122. The anode tube chamber 122 may be evacuated to a pressure below atmospheric pressure as stated herein. This evacuation feature advantageously offsets any pressure that builds up within anode tube chamber 122 when the anode tube chamber 122 is filled during the first charge or further recharge process of the electrochemical storage device with a desired anode material such as sodium and prevents mechanical failure of the anode tube chamber 122 due to overpressure that may be caused during the anode tube chamber 122 filling process.

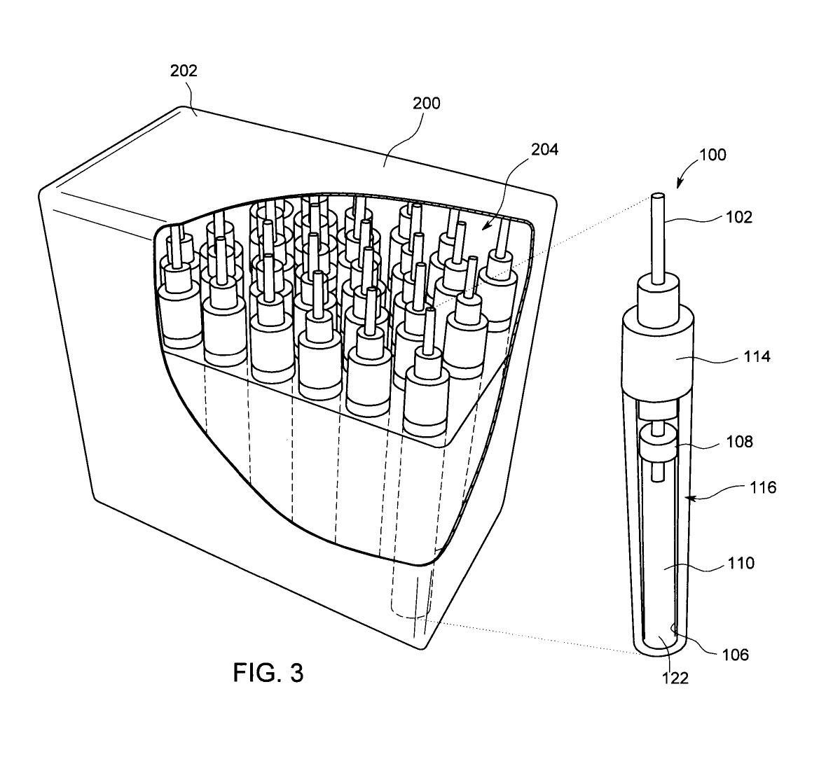

FIG. 3 illustrates one embodiment of an energy storage device 200 configured with a plurality of the pre-sealed anode tubes 100 shown in FIG. 2. As stated herein, a plurality of the resultant anode tube structures (anode tube assemblies) 100 may be inserted into and attached to a predetermined cathode case 202 to form a sodium-metal-halide energy storage device that exhibits an operational life and power density suitable for use in providing a cost-effective and reliable electric energy storage solution for electrical power grid renewable firming applications. Due at least in part to the use of a common cathode chamber 204, external to the plurality of anode chambers 122, the embodied energy storage device 200 is expected to exhibit power densities of up to five times greater than conventional energy storage devices, and in particular, conventional sodium-metal-halide energy storage devices.

In one embodiment, the anode tube chamber 122 may contain one or more anodic materials 110 that may function as an anode. A suitable material for the anodic material 110 supplying the transport ion is a Group I metal, such as sodium. Other suitable anodic materials may include one or both of lithium and potassium, and which may be used alternatively or additively with sodium. The anodic material 110 may be molten during use.

Additives suitable for use in the anodic material 110 may include a metal oxygen scavenger. Suitable metal oxygen scavengers may include one or more of manganese, vanadium, zirconium, aluminum, or titanium. Other useful additives may include materials that increase wetting of the solid electrolyte tube 116 surface by the molten anodic material. Additionally, some additives may enhance the contact or wetting of the solid electrolyte 116 with regard to the current collector 102, to ensure substantially uniform current flow throughout the solid electrolyte 116.

According to one embodiment, common cathode chamber 204 may contain one or more cathodic materials of which at least one cathodic material may present in elemental form and/or salt form; and the ratio of the weight percent of the cathodic material in elemental form to the weight percent of the salt form may be based on the state of charge.

Salts of the cathodic material may be metal halides. Suitable halides may include chloride. Alternately, the halide may include bromide, iodide or fluoride. In one embodiment, the halide may include chloride, and one or more additional halides. Suitable additional halide may include iodide or fluoride. In one embodiment, the additional halides are sodium iodide or sodium fluoride. The amount of additional halide may be greater than about 0.1 weight percent. In one embodiment, the amount is in range of from about 0.1 weight percent to about 0.5 weight percent, from about 0.5 weight percent to about 1 weight percent, from about 1 weight percent to about 5 weight percent, from about 5 weight percent to about 10 weight percent.

The shim assembly 104 may provide a thin gap adjacent to the solid electrolyte anode tube 116 to facilitate wicking of a thin layer of molten anodic material against a surface of the solid electrolyte 116. This wicking may be independent of the state of charge of the sodium-metal-halide energy storage device 200, and independent of the head height of anodic material.

The solid electrolyte (anode tube) 116 may be an alkali metal ion conductor solid electrolyte that conducts alkali metal ions during use. Suitable materials for the solid electrolyte 116 may include an alkali-metal-beta′-alumina, alkali-metal-beta″-alumina, alkali-metal-beta′-gallate, alkali-metal-beta″-gallate, a silicate or borosilicate glass, or an alkali pyrophosphate material. In one embodiment, the solid electrolyte 116 includes a beta alumina. In one embodiment, a portion of the solid electrolyte 116 is alpha alumina and another portion of the solid electrolyte 116 is beta alumina. The alpha alumina may be relatively more amenable to bonding (e.g., compression bonding) than beta alumina, and may help with sealing and/or fabrication of the energy storage device 200.

The solid electrolyte anode tube 116 may be stabilized by the addition of small amounts of, but not limited to lithia, magnesia, zinc oxide, yttria or similar oxides. These stabilizers may be used alone or in combination with themselves or with other materials. The solid electrolyte 116, sometimes referred to as beta alumina solid electrolyte (BASE) may include one or more dopants. Suitable dopants may include oxide of a transition metal selected from iron, nickel, copper, chromium, manganese, cobalt, or molybdenum. A solid electrolyte 116 having the dopants is referred to as beta alumina solid electrolyte, and has higher sodium ion conductivity than beta alumina. Sodium ion conductivity of one form of beta″ alumina solid electrolyte at 300 degrees Celsius is in a range of from about 0.2 ohm⁻¹ cm⁻¹ to about 0.4 ohm⁻¹ cm⁻¹.

The amount of the stabilizer added to the beta″ alumina can be greater than 0.5 weight percent. In some embodiments, the amount is in a range of from about 0.5 weight percent to about 1 weight percent, from about 1 weight percent to about 2 weight percent, from about 2 weight percent to about 3 weight percent, from about 3 weight percent to about 4 weight percent, from about 4 weight percent to about 5 weight percent, from about 5 weight percent to about 10 weight percent, from about 10 weight percent to about 15 weight percent, from about 15 weight percent to about 20 weight percent, or greater than about 20 weight percent based on the total weight of the beta″ alumina material.

The solid electrolyte tube 116 can be a tubular container in one embodiment having at least one wall. The wall can have a thickness; and an ionic conductivity and the resistance across the wall may depend in part on the thickness. Suitable thickness can be less than 5 millimeters. In some embodiments, the thickness is in a range of from about 5 millimeters to about 4 millimeters, from about 4 millimeters to about 3 millimeters, from about 3 millimeters to about 2 millimeters, from about 2 millimeters to about 1.5 millimeters, from about 1.5 millimeters to about 1.25 millimeters, from about 1.25 millimeters to about 1.1 millimeters, from about 1.1 millimeters to about 1 millimeter, from about 1 millimeter to about 0.75 millimeters, from about 0.75 millimeters to about 0.6 millimeters, from about 0 6 millimeters to about 0.5 millimeters, from about 0.5 millimeters to about 0.4 millimeters, from about 0.4 millimeters to about 0.3 millimeters, or less than about 0.3 millimeters.

The solid electrolyte (anode tube) 116 can be formed as a toughened ceramic, and can be formed with various modifiers that affect physical strength, vibration/shock resistance, ionic conductivity/resistance, and copper ion infiltration. To reduce a pressure differential across the solid electrolyte tube 116, the negative pressure generally caused on the cathode side by the change in the liquid electrolyte volume fraction during the re-charge/discharge reactions may be balanced by reducing the initial pressure on the anode side to less than ambient as stated herein before. The anode side may be sealed under vacuum, or a low pressure may be formed after sealing when the anode chamber 122 is sealed under some nominal pressure of an atmosphere of a gas at an elevated temperature and brought down to a lower temperature. Alternatively, a lower pressure on the anode side could be achieved by deploying a gettering material that reacts with the residual atmosphere (e.g. Oxygen, Nitrogen, and etc) to produce condensed reaction product species inside the anode chamber 122.

The anode current collector 102 is in electrical communication with the corresponding anode chamber 122. The anode current collector 102 may include an electrically conductive material. Suitable materials for the anode current collector 102 may include W, Ti, Ni, Cu, Mo, Fe, steel or combinations of two or more thereof. Other suitable materials for the anode current collector 102 may include carbon.

The cathode current collector may be a wire, paddle or mesh formed from Pt, Pd, Au, Mo, Cr, Ni, Cu, C, Fe or Ti. The cathode current collector may be plated or clad. Alternatively, the cathode current collector may be at least a portion of the device housing 202 that may comprise steel.

The cathode current collector can have thickness greater than 0.5 millimeter (mm). In some embodiments, the thickness is in a range of from about 1 millimeter to about 10 millimeters, from about 10 millimeters to about 20 millimeters, from about 20 millimeters to about 30 millimeters, from about 30 millimeters to about 40 millimeters, or from about 40 millimeters to about to about 50 millimeters. Cladding on the cathode current collector, if present, may coat the cathode current collector to a thickness greater than about 1 μm. In some embodiments, the cladding thickness is in a range of from about 1 micrometer (μm) to about 10 μm, from about 10 μm to about 20 μm, from about 20 μm to about 30 μm, from about 30 μm to about 40 μm, or from about 40 μm to about to about 50 μm.

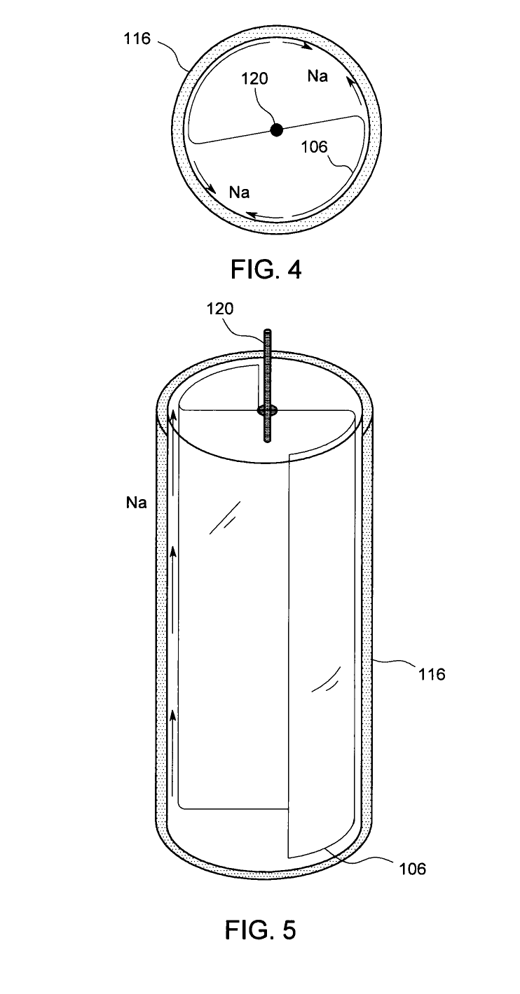

The feed-through current collector 120 comprises a shim assembly 104 that may be compatible with deviations in the shape of the anode tube chamber 122 while retaining its desired wicking capabilities. More specifically, shim assembly 104 may comprise a self-conforming shim 106 that is flexible enough to accommodate anode tube structural variations. According to one embodiment, shim assembly 104 comprises an s-shaped shim 106 such as depicted in FIGS. 4 and 5 when viewed in the axial direction of the pre-sealed anode tube 100. The s-shaped shim 106 is configured such that the outer surface of the shim 106 makes only partial contact with a corresponding anode tube 116 and also provides flexibility to achieve contact and/or maintain a small clearance with the inner surface of the anode tube 116 following insertion of the feed-through current collector 120 into the anode tube 116, even when the inner surface of the anode tube 116 is non-uniform or symmetric or is bent.

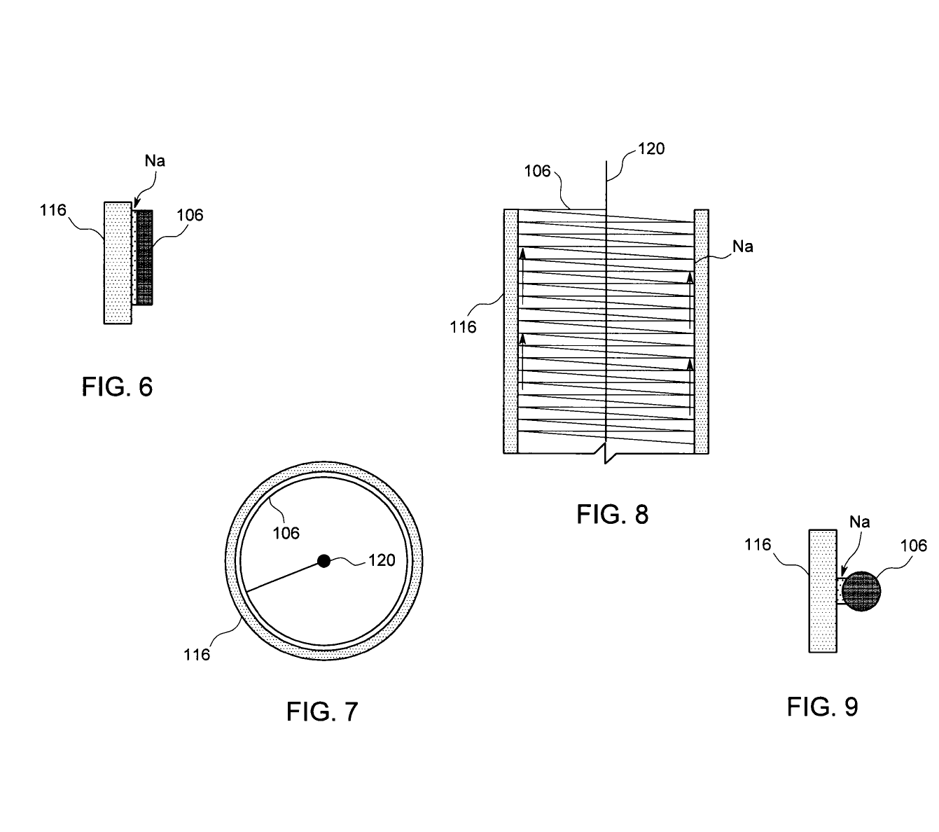

According to another embodiment, shim assembly 104 comprises a rolled metal plate in the shape of a cylinder. The rolled metal plate shim 106 is configured such that a small gap/clearance exists between the outer surface of the shim 106 and the inner surface of the anode tube 116 following insertion of the shim 106 into the anode tube 116. The metal plate is rolled in the shape of a tube and advantageously comprises a slotted sidewall to provide a desired amount of shim 106 flexibility to achieve contact and/or maintain a small clearance with the inner surface of the anode tube 116 following insertion of the feed-through current collector 120 into the anode tube 116, even when the inner surface of the anode tube 116 is non-uniform or symmetric or is bent. FIG. 6 illustrates the interface between a portion of the rolled metal plate shim 106 and the inner surface of the anode tube 116 according to one embodiment.

According to yet another embodiment, shim assembly 104 comprises a coiled wire shim 106 such as depicted in FIGS. 7-9. The shim 106 wire is coiled in the shape of a tube and advantageously provides flexibility to achieve contact and/or maintain a small clearance with the inner surface of the anode tube 116 following insertion of the feed-through current collector 120 into the anode tube 116, even when the inner surface of the anode tube 116 is non-uniform or symmetric or is bent. FIG. 7 illustrates a top view of the coiled wire shim 106 when viewed in the axial direction of the anode tube 116. FIG. 8 is a side view of the coiled wired shim 106 when viewed in a direction that is normal to the axis of the anode tube 116. FIG. 9 illustrates a circular cross section of one portion of the coiled wire shim 106 relative to the inner surface of a corresponding anode tube 116.

According to still another embodiment, shim assembly 104 comprises a coiled ribbon of metal to form the shim 106. The metal shim 106 ribbon has a non-circular cross section and is coiled in the shape of a tube that advantageously provides flexibility to achieve contact and/or maintain a small clearance with the inner surface of the anode tube 116 following insertion of the feed-through current collector 120 into the anode tube 116, even when the inner surface of the anode tube 116 is non-uniform or symmetric or is bent.

Other shim assembly 104 embodiments may employ umbrella or stent type shims 106 that can be inserted into the anode tube 116 and then opened up to be conforming to the inner wall of the anode tube 116.

In summary explanation, a pre-sealed anode tube 100 comprises a feed-through current collector assembly 120. The pre-sealed anode tube 100 chamber 122 is sealed to maintain a chamber 122 pressure below atmospheric pressure. The feed-through current collector assembly comprises a shim assembly 104 including a shim 106 that provides flexibility to achieve contact and/or maintain a small clearance with the inner surface of the anode tube 116 following insertion of the feed-through current collector 120 into the anode tube 116, even when the inner surface of the anode tube 116 is non-uniform or non-symmetric or is bent.

The pre-sealed anode tube 100 advantageously eliminates failures due to pressurization of the anode tube during an anode tube filling process, such as, without limitation, a sodium filling process. Further, the pre-sealed anode tube 100 advantageously allows creation of an independent inventory of anode tubes to achieve increased levels of quality and reliability, as well as reduced manufacturing, parts and replacement costs.

While only certain features and embodiments have been illustrated and described herein, many modifications and changes may occur to one of ordinary skill in the relevant art. Thus, it is intended that the scope of the invention disclosed should not be limited by the particular disclosed embodiments described above, but should be determined only by a fair reading of the claims that follow.

What is claimed is:

1. A pre-sealed anode tube assembly for a sodium-metal-halide energy storage device, the assembly comprising:
an anode tube; and
a feed-through current collector assembly at least partially sealed therein such that the pre-sealed anode tube assembly can be independently transported prior to being integrated with a desired electrical energy storage device.

2. The pre-sealed anode tube assembly wherein at least one portion of the feed-through current collector assembly is maintained prior to use at a pressure level within the sealed anode tube below atmospheric pressure.

3. The pre-sealed anode tube assembly according to claim 1, wherein the feed-through current collector assembly comprises a self-conforming shim.

4. The pre-sealed anode tube assembly according to claim 3, wherein the self-conforming shim is configured in the shape of an S when viewed in the axial direction of the pre-sealed anode tube.

5. The pre-sealed anode tube assembly according to claim 1, wherein the self-conforming shim comprises a rolled metal shim comprising a discontinuous circumferential wall.

6. The pre-sealed anode tube assembly according to claim 1, wherein the self-conforming shim comprises a coiled wire.

7. The pre-sealed anode tube assembly according to claim 1, wherein the self-conforming shim comprises a coiled metal ribbon having a non-circular cross-section.

8. The pre-sealed anode tube assembly according to claim 1, wherein the self-conforming shim is a flexible stent.

9. The pre-sealed anode tube assembly according to claim 1, wherein the feed-through current collector assembly comprises a shim configured to provide contact with the inner surface of the anode tube following insertion of the feed-through current collector into the anode tube, even when the inner surface of the anode tube is non-uniform or non-symmetric or is bent.

10. The pre-sealed anode tube assembly according to claim 1, wherein the feed-through current collector assembly comprises a shim configured to provide a small clearance with the inner surface of the anode tube following insertion of the feed-through current collector into the anode tube, even when the inner surface of the anode tube is non-uniform or non-symmetric or is bent.

11. The pre-sealed anode tube assembly according to claim 1, wherein the feed-through current collector assembly comprises a hollow needle or tubular metallic structure configured to provide a passage for evacuating air from within the anode tube.

12. The pre-sealed anode tube assembly according to claim 1, further comprising a gettering material that reacts with the residual atmosphere to produce condensed reaction product species inside the anode tube.

13. A method of forming a pre-sealed anode tube for a sodium-metal-halide energy storage device, the method comprising:
attaching an anode current collector to a shim to form a collector-shim assembly;
attaching a ceramic insulator to the collector-shim assembly to form a feed-through current collector;
inserting the feed-through current collector into a solid electrolyte tube; and
sealing the solid electrolyte tube to form a pre-sealed anode tube such that the pre-sealed anode tube can be independently transported and integrated with a desired sodium-metal-halide energy storage device.

14. The method of forming a pre-sealed anode tube according to claim 13, further comprising evacuating the solid electrolyte tube prior to sealing the solid electrolyte tube such that at least one portion of the feed-through current collector assembly is maintained prior to use at a pressure level within the pre-sealed anode tube below atmospheric pressure.

15. The method of forming a pre-sealed anode tube according to claim 13, wherein evacuating the solid electrolyte tube prior to sealing the solid electrolyte tube comprises pulling a vacuum through the anode current collector.

16. The method of forming a pre-sealed anode tube according to claim 13, wherein attaching an anode current collector to a shim to form a collector-shim assembly comprises attaching an anode current collector to a shim via a metal-metal joint.

17. The method of forming a pre-sealed anode tube according to claim 13, wherein attaching a ceramic insulator to the collector-shim assembly to form a feed-through current collector assembly comprises attaching a ceramic insulator to the collector-shim assembly via a ceramic-metal joint.

18. The method of forming a pre-sealed anode tube according to claim 13, wherein sealing the solid electrolyte anode tube comprises sealing the feed-through current collector assembly within the anode tube via a ceramic-ceramic joint.

19. The method of forming a pre-sealed anode tube according to claim 13, wherein sealing the solid electrolyte tube comprises:
sealing the solid electrolyte tube under a nominal pressure of an atmosphere of a gas at an elevated temperature; and
reducing the temperature.

20. The method of forming a pre-sealed anode tube according to claim 13, further comprising deploying a gettering material that reacts with the residual atmosphere to produce condensed reaction product species inside the anode tube.

21. A sodium-metal-halide energy storage device, comprising one or more pre-sealed anode tubes configured to be independently transported prior to being integrated with the sodium-metal-halide energy storage device.

22. The sodium-metal-halide energy storage device according to claim 21, wherein each pre-sealed anode tube comprises an internal pressure below atmospheric pressure prior to use.

23. The sodium-metal-halide energy storage device according to claim 21, wherein each pre-sealed anode tube comprises a wick enhancing self-conforming shim configured to provide contact with or a desired clearance with the inner surface of the anode tube following insertion of the shim into the anode tube, even when the inner surface of the anode tube is non-uniform or non-symmetric or is bent.
